(19) United States
(12) Patent Application Publication
(10) Pub. No.: US 2009/0006514 A1
(43) Pub. Date: Jan. 1, 2009

(54) METHOD AND DEVICE FOR NUMERICALLY GENERATING A FREQUENCY

(75) Inventor: Apostolos KOUNTOURIS, Grenoble (FR)

Correspondence Address: OBLON, SPIVAK, MCCLELLAND MAIER & NEUSTADT, P.C., 1940 DUKE STREET, ALEXANDRIA, VA, 22314, US

(73) Assignee: FRANCE TELECOM, Paris (FR)

(21) Appl. No.: 12/146,013

(22) Filed: Jun. 25, 2008

(30) Foreign Application Priority Data
Jun. 26, 2007 (FR) 07 56038

(51) Int. Cl. G06F 1/02

(52) U.S. Cl. 708/276

(57) ABSTRACT

To generate a digital signal at a given frequency, a step of calculating at least one trigonometric function for consecutive phases separated by a phase gap φ_{S} which is dependent on the frequency to be generated is repeated, and, during the step of calculating said trigonometric function for a phase of index k, k representing a phase incrementation index according to the phase gap φ_{S}, a result of the trigonometric function for the phase of index k is calculated on the basis of rounded results of the trigonometric function for the previous phase of index k−1 and for said phase gap respectively. A number N of rounded results of the trigonometric function for said phase gap φ_{S} and respective probabilities pᵢ of selecting said N rounded results being provided, one of the N rounded results for the phase gap φ_{S} is selected, taking account of the determined selection probabilities pᵢ, to calculate the result of the trigonometric function for the phase of index k.

### CROSS-REFERENCE TO RELATED APPLICATIONS

This application is based upon and claims the benefit of priority from France Patent Application No. 07 56038, filed Jun. 26, 2007, the entire contents of which are incorporated herein by reference.

### SUMMARY

The invention relates to a method and a device for numerically generating a digital signal of a given frequency.

To numerically generate a frequency, one solution consists in generating the discrete values of one or more trigonometric functions, for example cosine and sine, corresponding to the frequency to be generated, these discrete values corresponding to points situated on the curves of the trigonometric functions used.

Among the various existing digital frequency generation procedures, there is one, dubbed “recursive” or “iterative”, which is based on calculating sines and cosines of consecutive angles. This procedure relies on the following trigonometric identity:

e^{jφ}^{ₖ}=e^{j(kφ}^{ₛ}^{+φ}^{₀}⁾=e^{j[(k-1)φ}^{ₛ}^{+φ}^{₀}^{]}·e^{jφ}^{ₛ}=e^{jφ}^{_{k−1}}·e^{jφ}^{ₛ} (1)

where
φ₀ represents an initial phase, generally such that φ₀=0,
φₛ represents a constant phase gap, defined by the relation φₛ=2π·f_{c}/fₛ, where f_{c}, fₛ correspond respectively to the frequency to be generated and to a sampling frequency for the digital signal generated,
k represents a phase incrementation index for the calculation of sines and cosines of consecutive angles, or phases, such that k=1, 2, . . . .

Putting xₖ=cos φₖ and yₖ=sin φₖ.

It follows from identity (1) that:

−xₖ=xₖ₋₁·cos φₛ−yₖ₋₁·sin φₛ (2)

−yₖ=yₖ₋₁·cos φₛ+xₖ₋₁·sin φₛ (3)

Thus, the initial phase φ₀ and the phase gap φₛ being known, the sine and cosines values of the following phases φₖ for k=1, 2, 3, 4, . . . are deduced recursively, from the cosine and sine values of the initial phase φ₀. Stated otherwise, it is possible to calculate the values of the pairs (xₖ, yₖ) recursively, from the initial pair (x₀, y₀).

By way of illustrative example, we shall describe the calculation of the sines and cosines for k=1, k=2 and k=3, with an initial phase φ₀=0° and a phase gap φₛ=1°. For the requirements of the calculations, the cosine and the sine of the angle φₛ=1° are calculated and stored: cos(1°)=0.999848 and sin(1°)=0.017452.

Initially, for k=0, we have cos φ₀=1 and sin φ₀=0.

Thereafter, for k=1, cos φ₁ and sin φ₁ are calculated from cos φ₀ and sin φ₀ with the aid of equations (2) and (3):

x₁=x₀·cos(1°)−y₀·sin(1°)=1·cos(1°)−0·sin(1°)=0.999848

y₁=y₀·cos(1°)+x₀·sin(1°)=0·cos(1°)+1·sin(1°)=0.017452

Thereafter, for k=2, cos φ₂ and sin φ₂ are calculated from cos φ₁ and sin φ₁ with the aid of equations (2) and (3):

$$\begin{matrix}{x}_{2} = {x}_{1} \cdot cos ( 1 ° ) - {y}_{1} \cdot sin ( 1 ° ) \\ = ( 0.999848 ) \cdot ( 0.999848 ) - ( 0.017452 ) \cdot ( 0.017452 ) \\ = 0.999391\end{matrix}$$

$$\begin{matrix}{y}_{2} = {y}_{1} \cdot cos ( 1 ° ) + {x}_{1} \cdot sin ( 1 ° ) \\ = ( 0.017452 ) \cdot ( 0.999848 ) + ( 0.999848 ) \cdot ( 0.017452 ) \\ = 0.034899\end{matrix}$$

Thereafter, for k=3, cos φ₃ and sin φ₃ are calculated from cos φ₂ and sin φ₂ with the aid of equations (2) and (3):

$$\begin{matrix}{x}_{3} = {x}_{2} \cdot cos ( 1 ° ) - {y}_{2} \cdot sin ( 1 ° ) \\ = ( 0.999391 ) \cdot ( 0.999848 ) - ( 0.034899 ) \cdot ( 0.017452 ) \\ = 0.998629\end{matrix}$$

$$\begin{matrix}{y}_{3} = {y}_{2} \cdot cos ( 1 ° ) + {x}_{2} \cdot sin ( 1 ° ) \\ = ( 0.034899 ) \cdot ( 0.999848 ) + ( 0.999391 ) \cdot ( 0.017452 ) \\ = 0.052336\end{matrix}$$

The procedure thus makes it possible to recursively calculate the sines and cosines of consecutive angles.

Trigonometric calculations using standard trigonometric functions consume a great deal of calculation time. With the recursive procedure which has just been described for the trigonometric calculation of consecutive angles, the results of the sines and cosines of consecutive angles are calculated without calling upon trigonometric functions. Specifically, the calculations use the results of the sines and cosines of the phase gap φₛ and require that only multiplication and addition operations be carried out. This procedure thus exhibits the advantage of being able to be implemented with simple hardware and/or software means and of offering a constant calculation speed, independently of the precision required for the frequency generated. Its use is therefore particularly beneficial.

However, such a procedure for the trigonometric calculation of consecutive angles exhibits a major drawback: it is numerically unstable. This drawback is related to the fact that it is recursive, that is to say it calculates the values (xₖ, yₖ) from the previously calculated result (xₖ₋₁, yₖ₋₁), and that the numerical calculation means impose a finite precision for the calculations. In particular, the calculations of the values (xₖ, yₖ) are carried out on the basis of rounded values with the finite precision used of the values (xₖ₋₁, yₖ₋₁) and of the cosines and sines of the phase gap φₛ. Furthermore, the result provided by the calculation means for the pair of values (xₖ, yₖ) is itself a rounded value, an approximation of the real result of the calculations. Such approximations produce, at each phase increment k, an error in the calculations. This error feeds into the following calculations, corresponding to the phase increment (k+1), which amplify it further. As a function of the initial values of the pairs (x₀, y₀) and (xₛ, yₛ), the pair of calculated values (xₖ, yₖ) may either degenerate towards zero, or increase towards the infinity. This entails an evolving vicious circle producing a “snowball effect” which considerably and rapidly degrades the precision of the calculations. This is the reason why this procedure for numerically generating the frequency of consecutive angles is unusable in practice.

The present invention proposes a method of numerically generating a given frequency, in which
a step of calculating at least one trigonometric function for consecutive phases separated by a phase gap φ_{S} which is dependent on the frequency to be generated is repeated, and
during the step of calculating said trigonometric function for a phase of index k, k representing a phase incrementation index according to the phase gap φ_{S}, a result of the trigonometric function for the phase of index k is calculated on the basis of rounded results of the trigonometric function for the previous phase of index k−1 and for said phase gap respectively

which makes it possible to solve the numerical instability problem explained in the preceding paragraph.

For this purpose, a number N of rounded results of the trigonometric function for said phase gap φ_{S} and respective probabilities pᵢ of selecting said N rounded results being provided, the invention resides in the fact of selecting one of the N rounded results for the phase gap φ_{S}, and of calculating the result of the trigonometric function for the phase of index k taking account of the determined selection probabilities pᵢ.

The invention therefore consists in selecting each of the N rounded results of the trigonometric function for the phase gap with a predefined selection probability. The probabilities of drawing, or of selecting, the various rounded results can thus be chosen so as to ensure numerical stability of the iterative calculation method. Instead of accumulating and therefore amplifying, the successive rounding errors compensate one another and mutually cancel one another.

In a particular embodiment, to select one of the N rounded results for the phase gap φ_{S} taking account of the determined selection probabilities pᵢ,
a random number (l) uniformly distributed over a reference interval is generated;
the reference interval being divided into N disjoint intervals Iₙ of respective lengths proportional to the probabilities pᵢ with 1≦i≦N, the interval Ij, from among said N intervals Iₙ, to which the generated random number (l) belongs, is determined;
and, from among the N rounded results of the trigonometric function for the phase gap φ_{S}, that having the selection probability pⱼ corresponding to the length of the determined interval Ij is selected.

By virtue of this, the respective probabilities of selecting the various rounded results are taken into account in a simple and effective manner to select these rounded results during the iterative calculation process.

Advantageously, the rounded results being calculated with a finite precision of w bits on the fractional part, it being assumed that the results are represented using a fixed decimal point with w bits after the decimal point, the result of the trigonometric function for the phase of index k, obtained by multiplication of the rounded results of the trigonometric function for the previous phase of index k−1 and for the phase gap respectively, is rounded by truncating the fractional part of said result for the phase of index k by a portion of w bits and the value represented by the portion of the w truncated bits in the reference interval is determined so as to generate the random number.

The invention also relates to a device for numerically generating a given frequency comprising iterative calculation means designed to repeat the calculation of at least one trigonometric function for consecutive phases separated by a phase gap φ_{S} which is dependent on the frequency to be generated, the calculation of said trigonometric function for a phase of index k, k representing a phase incrementation index according to the phase gap φ_{S}, being carried out on the basis of a rounded result of the trigonometric function for the previous phase of index k−1 and of a rounded result of the trigonometric function for said phase gap respectively, characterized in that it comprises
means for storing a number N of rounded results of the trigonometric function for said phase gap φ_{S}
means for storing respective probabilities pᵢ of selecting said N rounded results
means for selecting one of the N rounded results for the phase gap φ_{S}, taking account of the determined selection probabilities pᵢ, to calculate the result of the trigonometric function for the phase of index k.

### BRIEF DESCRIPTION OF THE DRAWINGS

The invention will be better understood with the aid of the following description of the method and of the device for numerically generating a given frequency according to the invention, with reference to the appended drawings in which:

FIG. 1 represents a functional block diagram of a particular embodiment of the device of the invention;

FIG. 2 represents a flowchart of a particular embodiment of the method according to the invention, corresponding to the operation of the device of FIG. 1;

FIGS. 3A and 3B represent, on a trigonometric circle, a phase gap φₛ used in the method of FIG. 2.

### DETAILED DESCRIPTION

The method of the invention makes it possible to generate a digital signal with a given digital frequency, denoted f_{c}, by calculating at least one trigonometric function for consecutive angles. In the particular example of the description, the trigonometric function used is the complex exponential function defined in the following manner:

e^{jz}=cos(z)+j sin(z)

Let us first recall the following trigonometric identity:

e^{jφ}^{ₖ}=e^{j(kφ}^{ₛ}^{+φ}^{₀}⁾=e^{j[(k-1)φ}^{ₛ}^{+φ}^{₀}^{]}·e^{jφ}^{ₛ}=e^{jφ}^{_{k−1}}·e^{jφ}^{ₛ} (1)

where
φ₀ represents an initial phase, here φ₀=0,
φₛ represents a phase gap here constant, defined by the relation φₛ=2π·f_{c}/fₛ, where f_{c}, fₛ correspond respectively to the frequency to be generated and to a sampling frequency, and
k represents a phase incrementation index for calculating sines and cosines of consecutive angles, or phases.

The signal generated by the frequency generator is a digital signal, sampled at the sampling frequency fₛ. In order to comply with the Nyquist-Shannon criterion, the frequencies fₛ and f_{c} are such that

$$\frac{{f}_{s}}{{f}_{c}} \leq \frac{1}{2} .$$

It follows from this that the phase gap is such that φₛ≦π.

The initial phase φ₀ being zero, the following trigonometric identity is obtained:

e^{jφ}^{ₖ}=e^{jφ}^{_{k−1}}·e^{jφ}^{ₛ} (2)

From relation (2), the complex exponential function e^{jφ}^{ₛ} for the phase of index k is calculated from the result of the complex exponential function e^{jφ}^{_{k−1}} for the phase of index k−1 and the result of the complex exponential function e^{jφ}^{ₛ} for the phase gap φₛ.

Putting:

−xₖ=cos φₖ

−yₖ=sin φₖ

Then, it is possible to express the complex exponential function in the following manner:

e^{jφ}^{ₖ}=xₖ+j·yₖ

Additionally, for the sake of conciseness, we put:

xₖ+j·yₖ=(xₖ,yₖ)

The mathematical identity relation (2) yields the following relations:

$$k = 0 \\ ( {x}_{0} , {y}_{0} ) = ( cos {ϕ}_{0} , sin {ϕ}_{0} ) = cos {ϕ}_{0} + j \cdot sin {ϕ}_{0} \\ \begin{matrix}k = 1 , … \\ ( {x}_{k} , {y}_{k} ) = cos {ϕ}_{k} + j \cdot sin {ϕ}_{k} \\ = ( {x}_{k - 1} , {y}_{k - 1} ) \cdot ( cos {ϕ}_{s} + j \cdot sin {ϕ}_{s} ) \\ = ( {x}_{k - 1} + j \cdot {y}_{k - 1} ) \cdot ( cos {ϕ}_{s} + j \cdot sin {ϕ}_{s} ) \\ = ( {x}_{k - 1} \cdot cos {ϕ}_{s} - {y}_{k - 1} \cdot sin {ϕ}_{s} ) + \\ j ( {y}_{k - 1} \cdot cos {ϕ}_{s} + {x}_{k - 1} \cdot sin {ϕ}_{s} )\end{matrix} \qquad ( 3 )$$

In practice, the calculations are carried out with finite precision. In the nonlimiting particular example described here, this involves a precision of w bits on the fractional part (that is to say on the part of the number situated after the decimal point). Thus, the result of the calculation of the complex exponential function e^{jφ}^{ₖ} for the phase of index k is obtained from the approximate results of the complex exponential function respectively for the phase of index k−1, e^{jφ}^{_{k−1}}, and for the phase gap φₛ, e^{jφ}^{ₛ}, and itself undergoes a rounding of its fractional part on w bits.

Let Q_{w}

[symbol]

be a rounding operator with w bits on the fractional part. The function of this rounding operator, represented by the notation Q_{w}[.], is to round a number, having an integer part and a fractional part coded on a certain number of bits, by truncating the fractional part of the lowest order bits so as to preserve only the w bits of the fractional part of highest orders. The result obtained is an approximate result, that will also subsequently be called a “rounded result” or “approximation”, of the number considered, with a finite precision of w bits on the fractional part.

The result of the calculation of the complex exponential function, with finite precision of w bits on the fractional part, for the phase of index k is therefore:

Q_{w}[(xₖ,yₖ)]=Q_{w}[Q_{w}[(xₖ₋₁,yₖ₋₁)]·Q_{w}[(cos φₛ, sin φₛ)]] (4)

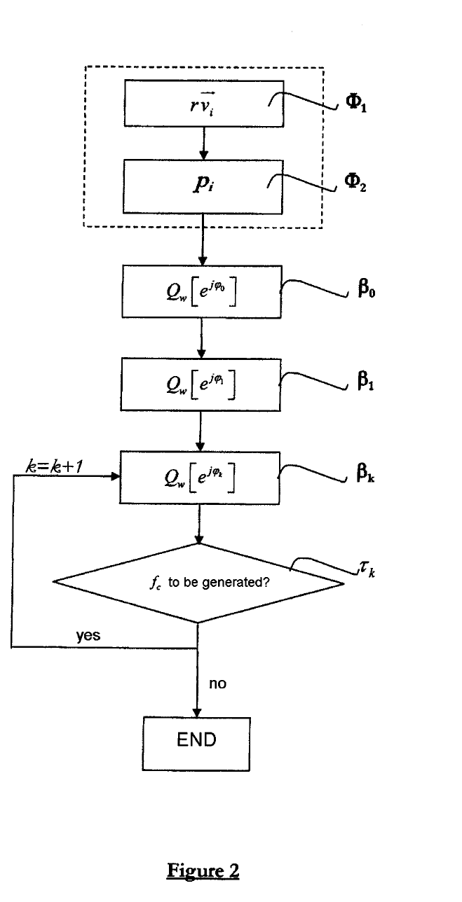

A particular embodiment of the method of the invention will now be described with reference to FIG. 2.

The method comprises a preliminary phase Φ comprising
a step Φ₁ of determining a given number N of possible rounded results, with the precision of w bits on the fractional part, of e^{jφ}^{ₛ} (that is to say of the complex exponential function for said phase gap φₛ;
a step Φ₂ of determining respective probabilities pᵢ of selecting the N possible rounded results, with 1≦i≦N determined in the step Φ₁.

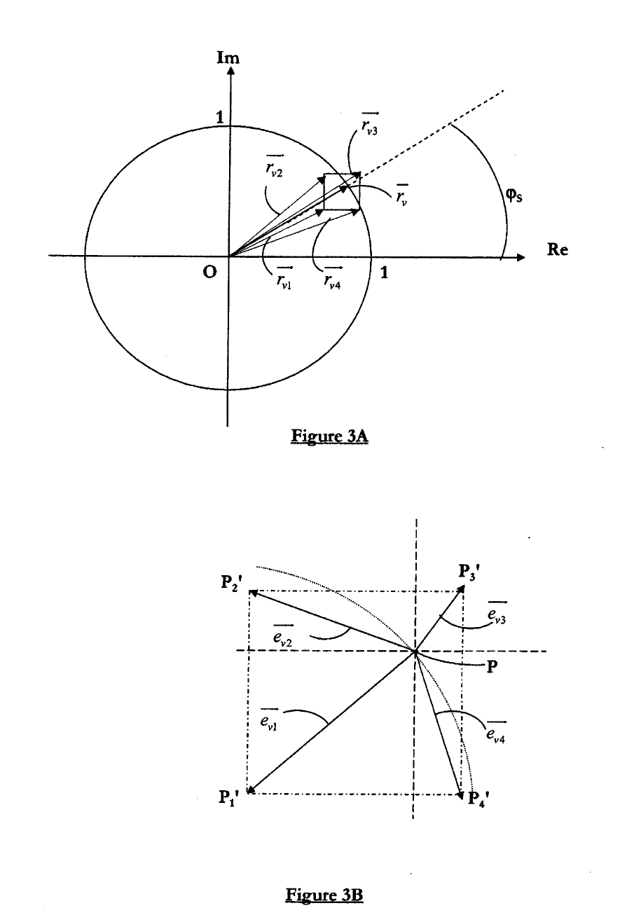

Represented in FIG. 3A is the trigonometric circle C in a complex plane associated with a right-handed orthonormal reference frame (O,\vec{u},\vec{w}), where (O,\vec{u}) and (O,\vec{w}) respectively represent the real axis, abscissa, and the imaginary axis, ordinate. The trigonometric circle C is centered on the origin O of the complex plane and its radius is equal to 1.

Also represented in the complex plane of FIG. 3A is a vector \vec{rᵥ}, that will subsequently be called the “phase rotation vector”, defined by the relation: \vec{rᵥ}=\vec{OP}, where
O represents the origin of the complex plane and
P represents the point of the complex plane defined the exponential expression e^{jφ}^{ₛ} and appearing in FIG. 3B; it is situated on the trigonometric circle C and corresponds to the angle φₛ on the circle C (φₛ=angle between the axis (O,\vec{u}) and \vec{rᵥ}=\vec{OP}).

Ultimately, the phase rotation vector \vec{rᵥ} models the complex exponential function for the phase gap φₛ, that is to say e^{jφ}^{ₛ}. In the particular example described here, the rounded results, determined in the step Φ₁, of the complex exponential function for the phase gap e^{jφ}^{ₛ}, stated otherwise of the phase rotation vector \vec{rᵥ}, are N=4 in number. They are modeled in FIG. 3A by four vectors \vec{rᵥ_{ᵢ}} with i=1, 2, 3, 4 such that \vec{rᵥ_{ᵢ}}=\vec{OPᵢ′}, Pᵢ′ representing the point of the complex plane defined by the exponential expression rₛ_{ᵢ}e^{jφ}^{ₛ} and appearing in FIG. 3B. The four points P₁′, P₂′, P₃′, P₄′ correspond to the four approximations of the point P and form a square, having two sides parallel to the axis (O,\vec{u}) and the other two to the axis (O,\vec{w}), inside which is situated the point P.

Represented in a more detailed manner in FIG. 3B are the square formed by the four points P₁′, P₂′, P₃′, P₄′, the point P situated in the interior, as well as four vectors representing the corresponding approximation errors. These approximation or rounding error vectors, denoted \vec{eᵥ_{₁}}, \vec{eᵥ_{₂}}, \vec{eᵥ_{₃}}, \vec{eᵥ_{₄}}, are defined by the point P, constituting the origin of each of them, and by the four approximation points P₁′, P₂′, P₃′, P₄′ respectively, in the following manner:

\vec{eᵥ_{ₛ}}=\vec{PPᵢ′} for 1≦i≦4

The sub-step Φ₂ of determining the respective probabilities of selecting the four possible approximation vectors \vec{rᵥ_{ᵢ}} with i=1, 2, 3, 4, stated otherwise the four corresponding rounded results of the complex exponential function for the phase gap, comprises the solving of the following system of equations:

$$\begin{matrix}\begin{matrix}- {\sum }_{i = 1}^{4} {p}_{i} = 1 & ( a )\end{matrix} \\ - {\sum }_{i = 1}^{4} {p}_{i} \cdot \vec{{e}_{{v}_{i}}} = 0 ⇔ \{ \begin{matrix}{\sum }_{i = 1}^{4} {p}_{i} \cdot {e}_{{x}_{i}} = 0 & ( b ) \\ {\sum }_{i = 1}^{4} {p}_{i} \cdot {e}_{{y}_{i}} = 0 & ( c )\end{matrix} \\ \begin{matrix}- min \{ {\sum }_{i = 1}^{4} {\vert {p}_{i} \cdot \vec{{e}_{{v}_{i}}} \vert}^{2} \} & ( d )\end{matrix}\end{matrix}$$

This system of equations conveys several conditions that the selection probabilities p₁, p₂, p₃, p₄ must comply with.

Equation (a) conveys the condition according to which the sum of the selection probabilities p₁, p₂, p₃, p₄ must be equal to 1.

Equations (b) and (c) convey the condition according to which, on average, the approximation error must be zero.

Equation (d) conveys the condition according to which the variance of the error, which corresponds to the energy of the error, must be a minimum.

To solve this system of equations, we proceed in the following manner:
we put p₄=x;
equations (a), (b) and (c) are solved so as to express the probabilities p₁, p₂, p₃ as a function of x;
the probabilities p₁, p₂, p₃, p₄ are substituted by their respective expressions as a function of x in the expression

$${\sum }_{i = 1}^{4} {\vert {p}_{i} \cdot \vec{{e}_{{v}_{i}}} \vert}^{2}$$

of equation (d) so as to determine

$$f ( x ) = {\sum }_{i = 1}^{4} {\vert {p}_{i} \cdot \vec{{e}_{{v}_{i}}} \vert}^{2} ;$$

the first derivative with respect to x of the function

$$f ( x ) = {\sum }_{i = 1}^{4} {\vert {p}_{i} \cdot \vec{{e}_{{v}_{i}}} \vert}^{2} ,$$

i.e.

$$\frac{d ( {\sum }_{i = 1}^{4} {\vert {p}_{i} \cdot \vec{{e}_{{v}_{i}}} \vert}^{2} )}{d x} ,$$

is calculated and the equation

$$\frac{d ( {\sum }_{i = 1}^{4} {\vert {p}_{i} \cdot \vec{{e}_{{v}_{i}}} \vert}^{2} )}{d x} = 0$$

is solved to minimize the expression

$${\sum }_{i = 1}^{4} {\vert {p}_{i} \cdot \vec{{e}_{{v}_{i}}} \vert}^{2} .$$

Finally, since we are dealing with probabilities, a check is made to verify that pᵢ≧0 for i=1, 2, 3, 4. If this is not the case, the value 0 is assigned to each probability pᵢ which is negative and equations (a), (b) and (c) are solved to calculate the remaining unknown probabilities.

Solving this system of equations thus makes it possible to obtain the respective values of the selection probabilities p₁, p₂, p₃, p₄ for the vectors \vec{rᵥ_{ᵢ}} with i=1, 2, 3, 4 approximating the phase rotation vector \vec{rᵥ}.

Following this initial phase Φ of calculating the respective probabilities of selecting the four approximations of the result of the function e^{jφ}^{ₛ}, the method comprises the execution of a calculation loop, fed with the four rounded results of the complex exponential function for the phase gap and with their respective selection probabilities. This loop is executed for as long as the frequency f_{c} has to be generated.

This loop comprises the repetition of a step of calculating the complex exponential function for consecutive phases φₖ, for k=0, 1, 2 . . . . Two consecutive phases are separated from one another by the phase gap φₛ; stated otherwise we have the relation: φₖ=φₖ₋₁+φₛ

The loop comprises a first step β₀, termed the initialization step, for the index k=0.

During this step β₀, the value of Q_{w}[e^{jφ}^{ₛ}], stated otherwise the rounding of e^{jφ}^{₀} with a precision of w bits on the fractional part, is stored in the storage memory 1, if appropriate instead of the previous content of the memory 1.

Step β₀ is followed by a step β₁ corresponding to the incrementation index k=1 of calculating the complex exponential function for the phase φ₁=φ₀+φ_{S}. During this step β₁, the following sub-steps are carried out so as to calculate a rounding of e^{jφ}^{ₛ} with a precision of w bits on the fractional part, denoted Q_{w}[e^{jφ}^{ₛ}]:
β1,1) One of the rounded results of e^{jφ}^{ₛ}, denoted Q_{w}[e^{jφ}^{ₛ}], is selected from among the four rounded results determined during the initial phase Φ. Stated otherwise, by vector modeling, one of the four approximation vectors \vec{rᵥ_{ᵢ}} with i=1, 2, 3, 4 is selected as approximation of the phase rotation vector \vec{rᵥ}. For the first selection (that is to say for k=1), the most probable approximation vector \vec{rᵥ_{ᵢ}} is selected, that is to say that having the highest selection probability pᵢ. In this instance, this is

$$\vec{{r}_{{v}_{3}}} = {r}_{3} {e}^{{jϕ}_{{s}_{3}}} .$$

β1,2) The rounded result of the complex exponential function for the previous phase φ₀, i.e. Q_{w}[e^{jφ}^{₀}], and the selected rounded result of the complex exponential function for the phase gap φₛ, i.e.

$${Q}_{w} [ {e}^{{jϕ}_{s}} ] = {r}_{3} {e}^{{jϕ}_{{s}_{3}}} ,$$

, are multiplied. Stated otherwise, the following multiplication operation is carried out:

Q_{w}[e^{jφ}^{₀}]·Q_{w}[e^{jφ}^{ₛ}]
It will be noted that the multiplication of two roundings, each having a precision of w bits on their fractional part, provides a result having a precision of 2w bits on its fractional part.
β1,3) The rounding of the result obtained in the previous sub-step β_{1,2}) is then calculated with the aid of the operator Q_{w}[.]. The following operation is thus carried out:

Q_{w}[Q_{w}[e^{jφ}^{₀}]·Q_{w}[e^{jφ}^{ₛ}]]=Q_{w}[e^{jφ}^{₁}]
The rounding operator truncates the fractional part of the result obtained in sub-step β_{1,2}) by a portion of w bits. A rounded result of e^{jφ}^{₁}, denoted Q_{w}[e^{jφ}^{₂}], is thus obtained with a precision of w bits on the fractional part.
β1,4) The rounded result of the exponential function obtained for the phase φ₁, denoted Q_{w}[e^{jφ}^{₁}], is stored in the storage register 1 intended to feed the calculation step for the following phase φ₂.

Step β₁ is followed by a succession of steps βₖ for k=2, 3, . . . .

A calculation step βₖ for k=2, 3, . . . , calculates a rounding, or approximate result, with a precision of w bits on the fractional part of the complex exponential function for the phase φₖ. This approximate result is denoted Q_{w}[e^{jφ}^{ₖ}]. The step βₖ comprises the following sub-steps:
βκ,1) during a first sub-step β_{k,1}, the value of a selection index is determined from among a set of N indices, namely the set {1,2,3,4}, it being recalled that N=4.
   To determine this selection index, a random number lₖ is generated, uniformly distributed over a reference interval I_{ref}, here I_{ref}=[0,1]. The fact that the random number lₖ is uniformly distributed over the interval [0,1] signifies that it may take, with the same probability, numerical values in sub-intervals of the interval [0,1] of the same respective lengths.
   The reference interval I_{ref}=[0,1] is divided into N sub-intervals Iₙ, with 1≦n≦4, it being recalled that N=4. The various intervals Iₙ are disjoint and here of respective lengths equal to the selection probabilities pₙ with 1≦n≦4 determined during the preliminary phase Φ. The sub-intervals Iₙ are defined in the following manner:

I₁=[0,p₁[

I₂=[p₁,p₁+p₂[

I₃=[p₁+p₂,p₁+p₂+p₃[

I₄=[p₁+p₂+p₃,p₁+p₂+p₃p₄]
The sub-interval Iₙ to which the random number lₖ generated belongs is determined. It is assumed that the number lₖ belongs to the sub-interval Ij of length pⱼ. The index j of the selection probability pⱼ corresponding to the length of the determined interval Ij is then allocated to the selection index to be determined. Consequently, the selection index j is such that:
   if lₖεI₁, then j=1
   if lₖεI₂, then j=2
   if lₖεI₃, then j=3
   if lₖεI₄, then j=4
βκ,2) With the aid of the selection index j determined in step β_{k,1}, the rounded result having the probability of selecting index j, i.e. p_{j.}, is selected from among the four rounded results of the complex exponential function for the phase gap determined during the initial phase Φ. Thus, we chose

$${Q}_{w} [ {e}^{{jϕ}_{s}} ] = {r}_{3} {e}^{{jϕ}_{{s}_{j}}} .$$

Stated otherwise, in vector modeling, the approximation vector \vec{rᵥ_{₁}} is selected as approximation of the vector \vec{rᵥ}.
βκ,3) The rounded result of the complex exponential function for the previous phase φₖ₋₁, i.e. Q_{w}[e^{jφ}^{_{k−1}}], and the rounded result of the complex exponential function for the phase gap φ_{S}, Q_{w}[e^{jφ}^{ₖ}], selected in the step β_{k,2}, are multiplied. Stated otherwise, the expression Q_{w}[e^{jφ}^{_{k−1}}]·Q_{w}[e^{jφ}^{ₛ}] is calculated, with Q_{w}[e^{jφ}^{ₛ}]=\vec{rᵥ_{₁}}.
   The calculation consisting in multiplying two roundings each having a precision of w bits on their fractional part, the result obtained has a fractional part coded on 2w bits.
βκ,4) The rounding of Q_{w}[e^{jφ}^{_{k−1}}]·W_{w}[e^{jφ}^{ₛ}] is then calculated with the aid of the rounding operator Q_{w}[+], that is to say the rounding with a precision of w bits on the fractional part of the result of sub-step β_{k,3}. For this purpose, the fractional part of the result obtained in sub-step β_{k,3} of the w lowest order bits is truncated. A rounded result of e^{jφ}^{ₛ} is thus obtained with a precision of w bits on its fractional part (corresponding to the remaining w bits, of highest orders), denoted Q_{w}[e^{jφ}^{ₖ}].
βκ,5) The rounded result thus obtained, Q_{w}[e^{jφ}^{ₖ}], is stored in the storage memory 1 so as to feed the calculation step for the following phase φₖ₊₁.

During sub-step β_{k,1}, the random number lₖ can be generated by a pseudo-random number generator, known to the person skilled in the art. To generate this random number lₖ, it is also possible to use a batch of w bits truncated by the rounding operator Q_{w}[·] in the previous calculation step βₖ₋₁, and more precisely in sub-step β_{k-1,4}. In fact, in the previous calculation step βₖ₋₁, the rounding operator has calculated two rounded results: one on the real part and the other on the imaginary part. The rounding operator therefore produces two batches of w truncated bits. To generate the random number lₖ, it is possible to use one of these two batches or even a concatenation of w/2 bits of one of the batches and of w/2 bits of the other batch. The value represented is determined by the batch of w bits truncated in the reference interval I_{ref}, here I_{ref}=[0,1]. For example, if we take w=4 and 4 truncated bits equalling 1 0 1 1, the value represented by these bits in the interval [0,1] is 2⁻¹+2⁻³+2⁻⁴=0.6875. Stated otherwise, the w truncated bits are translated into a value included in the reference interval I_{ref}. This value constitutes the random number lₖ of index k.

The calculation step βₖ is thus repeated for consecutive phases φₖ separated pairwise by a phase gap φ_{S} so long as a digital signal of frequency f_{c} has to be generated. A test step τₖ for verifying whether the frequency f_{c} still has to be generated is therefore carried out at the end of each step βₖ. If it is appropriate to continue the generation of frequency f_{c}, step βₖ₊₁ is executed. Otherwise, the method is interrupted.

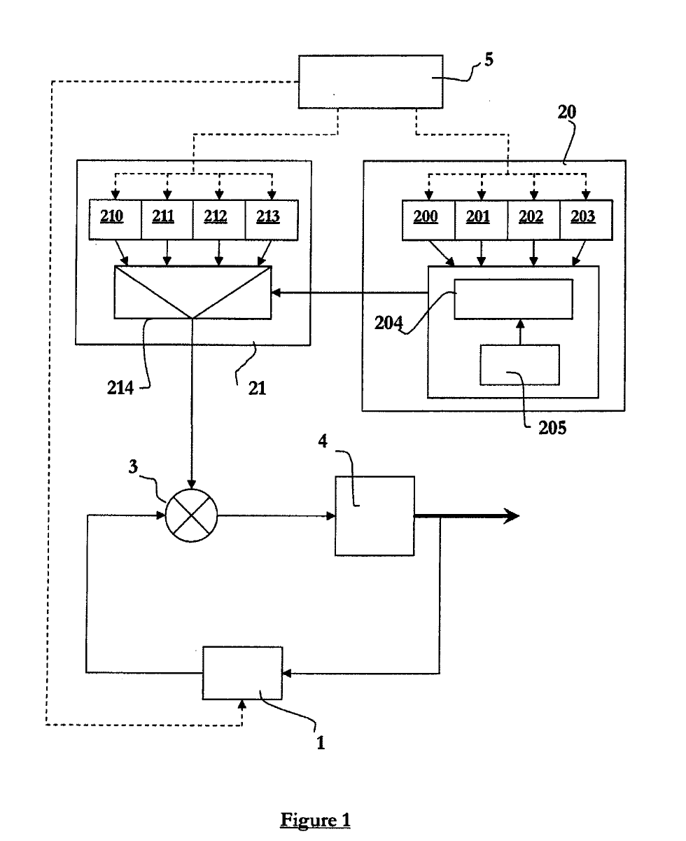

A particular form of realization of the device for generating a digital frequency, able to implement the method which has just been described, will now be described with reference to FIG. 1.

The device represented in FIG. 1 comprises a storage memory 1, a selection module 2, a multiplier 3 and a rounding operator 4.

The storage memory 1 is here a shift register intended to receive and to provisionally store the result of each calculation step βₖ, stated otherwise the rounding Q_{w}[e^{jφ}^{ₖ}], obtained on completion of calculation step βₖ. The result Q_{w}[e^{jφ}^{ₖ}] of a calculation step βₖ is stored in the memory 1 instead of the result Q_{w}[e^{jφ}^{_{k−1}}] of the previous calculation step βₖ₋₁. On initialization, that is to say in step β₀, the storage memory 1 is reinitialized so as to store the rounding of the complex exponential function for the initial phase φ₀, that is to say Q_{w}[e^{jφ}^{ₖ}].

The selection module 2 comprises
a sub-module 20 for determining a selection index j;
a sub-module 21 for providing an approximate result of the complex exponential function for the phase gap φ_{S}.

The sub-module 20 for determining a selection index j comprises
N memories 200-203, with N=4, for storing the respective probabilities p₁, p₂, p₃, p₄ of selecting the four approximate results of the complex exponential function for the phase gap φ_{S};
a pseudo-random generator 204 intended to generate the random number lₖ uniformly distributed over the reference interval I_{ref}=[0,1];
a block 205 for determining a selection index j linked to the four memories 200 to 203 and to the output of the pseudo-random generator 204.

The sub-module 20 is designed to implement sub-step β_{k,1}. During operation, in each calculation step βₖ, the generator 204 generates the random number lₖ uniformly distributed over the reference interval [0,1] and provides it to the block 205 for determining a selection index j. The block 205 determines the sub-interval to which the number lₖ belongs from among the four sub-intervals I₁, I₂, I₃ and I₄ of the reference interval [0,1] which are defined by the probabilities p₁, p₂, p₃, p₄ in the following manner:

I₁=[0,p₁[; I₂=[p₁,p₁+p₂[; I₃=[p₁+p₂,p₁+p₂+p₃[; I₄=[p₁+p₂+p₃,p₁+p₂+p₃+p₄]

The random number lₖ belonging to the interval Ij, the sub-module 20 allocates the value j to the selection index and provides the latter to the sub-module 21.

In the case where the random number lₖ is generated from the w truncated bits in the previous calculation step βₖ₋₁, the device comprises a connection between an additional output of the rounding operator, intended to deliver the w bits truncated by the rounding operator in each calculation step βₖ, and an additional input of the sub-module 20 for determining the selection index j. Furthermore, the sub-module 20 comprises a memory for storing the w truncated bits provided at each calculation step by the rounding operator 4 and means for determining the value represented by these w truncated bits, which corresponds to the random number used during the following calculation step to determine the selection index j.

Furthermore, during the initial step β₀ of the calculation loop (that is to say for k=0), the module 20 for determining a selection index j is designed to allocate to the selection index j the value of the index i of the highest probability pᵢ out of the four probabilities p₁, p₂, p₃, p₄.

The sub-module 21 for providing an approximate result of the complex exponential function for the phase gap φ_{S} comprises
four memories 210-213 for storing the four approximations r₁e^{jφ}^{_{S1}}, r₂e^{jφ}^{_{S2}}, r₃e^{jφ}^{_{S3}}, r₄e^{jφ}^{_{S4}} of the complex exponential function for the phase gap φ_{S}, modeled by the four approximation vectors r\vec{v₁}, r\vec{v₂}, r\vec{v₃}, r\vec{v₄}
a multiplexer 214 connected at input, on the one hand, to the four memories 200-203 and, on the other hand, to the module 20 for determining a selection index j, and at output to the multiplier 3.

The multiplexer 214 is designed to select one of the four approximations of the complex exponential function for the phase gap φ_{S} stored in the memories 210 to 213, as a function of the value of the selection index j transmitted by the sub-module 20. During operation, the multiplexer selects the approximation rⱼe^{jφ}^{_{S}} corresponding to the index j received.

During operation, in calculation sub-step βₖ, the approximate result of the complex exponential function for the phase φₖ₋₁, stored in the memory 1, and the approximate result of the complex exponential function for the phase gap φ_{S}, provided by the sub-module 21, are fed as input to the multiplier 3. It multiplies the two approximate results (Q_{w}[e^{jφ}^{_{k−1}}]·Q_{w}[e^{jφ}^{ₛ}] with Q_{w}[e^{jφ}^{ₛ}]=r\vec{vⱼ}) and provides the result obtained to the rounding operator 4. The latter determines the rounding of the result of the multiplication by truncating the w lowest order bits of the fractional part so as to obtain an approximate result of e^{jφ}^{ₖ} with a precision of w bits on its fractional part, denoted Q_{w}[e^{jφ}^{ₖ}]. This result is output by the device and recorded in parallel in the memory 1, for the following calculation sub-step βₖ₊₁, instead of Q_{w}[e^{jφ}^{_{k−1}}].

The digital frequency generation device also comprises a configuration module 5 and a control module 6, in this instance a microprocessor.

The configuration module 5 is designed to implement the two steps Φ₁, Φ₂ of the preliminary phase Φ, so as to determine, on the basis of a phase gap φ_{S} provided, the four approximations r₁e^{jφ}^{_{S1}}, r₂e^{jφ}^{_{S2}}, r₃e^{jφ}^{_{S3}}, r₄e^{jφ}^{_{S4}} of the complex exponential function for the phase gap φ_{S} (modeled by the four approximation vectors \vec{rᵥ_{₁}}, \vec{rᵥ_{₂}}, \vec{rᵥ_{₃}}, \vec{rᵥ_{₄}}) and to calculate the four corresponding selection probabilities p₁, p₂, p₃, p₄. The four approximations of the complex exponential function for the phase gap φ_{S} are stored in the memories 210 to 213 respectively and their corresponding probabilities are stored in the memories 200 to 203.

Furthermore, the configuration module 5 is designed to reinitialize the memory 1, by recording therein the approximate result, stored in memory, of the complex exponential function for the initial phase φ₀, at the start of each new calculation loop. The frequency generation device could itself be adapted for calculating the initialization value Q_{w}[e^{jφ}^{₀}], for example by implementing the so-called “CORDIC” procedure which makes it possible to calculate trigonometric functions to the desired precision.

All the elements of the device are connected to the control module 6 which is designed to control the operation thereof.

The elements 204 and 205 of the selection module, the multiplexer 214, the multiplier 3, the rounding operator 4 and the configuration module 5 are, in the particular example described, software modules forming a computer program. The invention therefore also relates to a computer program for a device for numerically generating a given frequency comprising software instructions for implementing the method described above, when said program is executed by the device. The program can be stored in or transmitted by a data medium. The latter can be a hardware storage medium, for example a CD-ROM, a magnetic diskette or a hard disk, or else a transmissible medium such as an electrical, optical or radio signal. The invention also relates to a recording medium readable by a computer on which the program is recorded.

As a variant, these software modules could at least partially be replaced with hardware means.

The digital frequency generation device described above can be integrated into radiocommunication equipment.

In the preceding description, the number N of rounded results of the complex exponential function for the phase gap is equal to four. The invention is not however limited to this particular exemplary embodiment. Of course, the invention could use a number N of rounded results that is less than or greater than four.

The invention applies to all the techniques requiring the numerical generation of a frequency: digital musical instruments, audio synthesis, radiocommunication. In the field of radiocommunications, the invention can be used within the framework of the following operations:
frequency translation (modulation, demodulation),
slaving of the carrier frequency at reception,
generation of the FFT coefficients,
multiband filtering, etc.

In the preceding description, a new procedure for generating random numbers has been explained. According to this new procedure, to generate a succession of random numbers, use is made of the w bits truncated by the rounding operator of the fractional part of the results successively obtained, for consecutive phases φₖ (with k=1, 2, . . . ) separated by the phase gap φ_{S}, by multiplication between the two rounded results of a trigonometric function respectively for the phase φₖ and for the phase gap φ_{S}. Such a procedure for generating random numbers can be used in applications requiring the generation of random numbers, apart from frequency generation. It can be implemented in a pseudo-random generator having the initial phase φ₀ and the phase gap φ_{S} as configuration parameters.

1. A computer implemented method of numerically generating a given frequency, comprising:
calculating at least one trigonometric function for consecutive phases separated by a phase gap φ_{S} which is dependent on the frequency to be generated is repeated, during the calculating of said trigonometric function for a phase of index k, k representing a phase incrementation index according to the phase gap φ_{S}, a result of the trigonometric function for the phase of index k is calculated on the basis of rounded results of the trigonometric function for the previous phase of index k−1 and for said phase gap respectively;
wherein, a number N of rounded results of the trigonometric function for said phase gap φ_{S} and respective probabilities pᵢ of selecting said N rounded results being provided, one of the N rounded results for the phase gap φ_{S} is selected, taking account of the determined selection probabilities pᵢ, to calculate the result of the trigonometric function for the phase of index k.

2. The method as claimed in claim 1, in which, to select one of the N rounded results for the phase gap φ_{S} taking account of the determined selection probabilities pᵢ,
a random number (l) uniformly distributed over a reference interval is generated;
the reference interval being divided into N disjoint intervals Iₙ of respective lengths proportional to the probabilities pᵢ with 1≦i≦N, the interval Ij, from among said N intervals Iₙ, to which the generated random number (l) belongs, is determined;
and, from among the N rounded results of the trigonometric function for the phase gap φ_{S}, that having the selection probability pⱼ corresponding to the length of the determined interval Ij is selected.

3. The method as claimed in claim 2, in which the rounded results being calculated with a finite precision of w bits on the fractional parts, the result of the trigonometric function for the phase of index k, obtained by multiplication of the rounded results of the trigonometric function for the previous phase of index k−1 and for the phase gap respectively, is rounded by truncating the fractional part of said result for the phase of index k by a portion of w bits and the value represented by said portion of w bits truncated in the reference interval is determined so as to generate the random number.

4. The method as claimed in claim 1, in which there is provided a preliminary phase comprising:
determining the N rounded results of the trigonometric function for said phase gap φ_{S};
determining respective probabilities pᵢ of selecting the N possible approximated values, with 1≦i≦N.

5. The method as claimed in claim 4, in which the number N of rounded results of the trigonometric function for the phase gap φ_{S} is equal to four and the four rounded results correspond to the four vertices of a square containing a point of the trigonometric circle representing the phase gap φ_{S}.

6. The method as claimed in claim 4, in which the N respective probabilities pᵢ with 1≦i≦N of selecting the N rounded results are determined in such a way that the mean of the rounding error is zero.

7. The method as claimed in claim 4, in which the N respective probabilities pᵢ with 1≦i≦N of selecting the N rounded results are determined so as to minimize the variance of the error.

8. The method as claimed in claim 4, in which the N respective probabilities pᵢ with 1≦i≦N of selecting the N rounded results are determined in such ways that the sum of the respective probabilities of selecting the N rounded results is equal to 1.

9. The method as claimed in claim 4, in which, to determine the N respective probabilities pᵢ with 1≦i≦N of selecting the N rounded results, the following system of equations is solved:
$$\begin{matrix}\begin{matrix}{\sum }_{i = 1}^{4} {p}_{i} = 1 & ( a )\end{matrix} \\ {\sum }_{i = 1}^{4} {p}_{i} \cdot \vec{{e}_{{v}_{i}}} = 0 ⇔ \{ \begin{matrix}{\sum }_{i = 1}^{4} {p}_{i} \cdot {e}_{{x}_{i}} = 0 & ( b ) \\ {\sum }_{i = 1}^{4} {p}_{i} \cdot {e}_{{y}_{i}} = 0 & ( c )\end{matrix} \\ \begin{matrix}min \{ {\sum }_{i = 1}^{4} {\vert {p}_{i} \cdot \vec{{e}_{{v}_{i}}} \vert}^{2} \} & ( d )\end{matrix}\end{matrix}$$
where \vec{eᵥ_{ᵢ}} represent approximation error vectors with
$$\vec{{e}_{{v}_{i}}} = ( \begin{matrix}{e}_{{x}_{i}} \\ {e}_{{y}_{i}}\end{matrix} )$$
in an orthonormal reference frame.

10. A device for numerically generating a given frequency comprising iterative calculation means designed to repeat the calculation of at least one trigonometric function for consecutive phases separated by a phase gap φ_{S} which is dependent on the frequency to be generated, the calculation of said trigonometric function for a phase of index k, k representing a phase incrementation index according to the phase gap φ_{S}, being carried out on the basis of a rounded result of the trigonometric function for the previous phase of index k−1 and of a rounded result of the trigonometric function for said phase gap respectively, comprising:
means for storing a number N of rounded results of the trigonometric function for said phase gap φ_{S}
means for storing respective probabilities pᵢ of selecting said N rounded results
means for selecting one of the N rounded results for the phase gap φ_{S}, taking account of the determined selection probabilities pᵢ, to calculate the result of the trigonometric function for the phase of index k.

11. An item of radiocommunication equipment integrating the digital frequency generation device as claimed in claim 10.

12. A computer readable storage medium encoded with computer program instructions which cause a computer to implement a method of numerically generating a given frequency, comprising:
calculating at least one trigonometric function for consecutive phases separated by a phase gap φ_{S} which is dependent on the frequency to be generated is repeated, during the calculating of said trigonometric function for a phase of index k, k representing a phase incrementation index according to the phase gap φ_{S}, a result of the trigonometric function for the phase of index k is calculated on the basis of rounded results of the trigonometric function for the previous phase of index k−1 and for said phase gap respectively;
wherein, a number N of rounded results of the trigonometric function for said phase gap φ_{S} and respective probabilities pᵢ of selecting said N rounded results being provided, one of the N rounded results for the phase gap φ_{S} is selected, taking account of the determined selection probabilities pᵢ, to calculate the result of the trigonometric function for the phase of index k.
